(19) United States
(12) Patent Application Publication
(10) Pub. No.: US 2018/0279644 A1
(43) Pub. Date: Oct. 4, 2018

(54) CHEWING GUM COMPRISING A XYLITOL COATING

(71) Applicant: WM. WRIGLEY JR. COMPANY, Chicago, IL (US)

(72) Inventors: Enrique VALDEZ, Chicago, IL (US); Carol SINOPLE, Chicago, IL (US)

(21) Appl. No.: 15/764,550

(22) PCT Filed: Sep. 29, 2016
(86) PCT No.: PCT/US16/54327

§ 371 Date: Mar. 29, 2018

Related U.S. Application Data
(60) Provisional application No. 62/235,446, filed on Sep. 30, 2015.

(51) Int. Cl. A23G 4/20; A23G 4/06; A23G 4/10

(52) U.S. Cl. CPC A23G 4/20; A23G 4/062; A23V 2200/22; A23V 2002/00; A23V 2250/6422; A23G 4/10

(57) ABSTRACT

A chewing gum includes a xylitol coating applied as multiple layers of a coating syrup. The coating syrup contains a xylitol solution that is the product of xylose hydrogenation and includes impurities such as other sugars or sugar alcohols which are the natural byproducts of xylitol production process. The xylitol coating applied in this manner provides cost and energy savings as compared to prior art xylitol coated chewing gums.

### BACKGROUND OF THE INVENTION

The present invention relates chewing gums which include a xylitol coating. The xylitol coating is applied via a xylitol solution that is obtained by hydrogenation of a xylose solution and is used without crystallization or other purification steps.

Traditional chewing gums comprise a water insoluble portion (essentially the gum base) and a water soluble portion which consists mostly of sugars and or sugar alcohols and which typically constitutes 60 to 75% of the product. In addition to providing sweetness to the product, the bulking agent also softens the initial texture of the product. Other ingredients including flavor, softeners, colors acidulants and the like are also considered to be part of the water-soluble portion.

Chewing gums are frequently manufactured in the form of a pellet or ball having a hard coating. The coating is typically formed by applying layers of a sugar or sugar alcohol solution which are dried to form the coating.

Crystalline xylitol is often used as a bulking agent and coating material in sugarless chewing gums. This sugar alcohol (or polyhydric alcohol or polyol) has benefits of sugar-like sweetness, low hygroscopicity and non-cariogenicity or even anti-cariogenicity which make it extremely desirable and useful for this purpose. It also produces a crunchy coating with good shelf life and moisture resistance. However, xylitol does have some disadvantages, such as higher cost than other sugar alcohols. It also may take more energy to produce xylitol than other sugar alcohols making it less environmentally friendly.

### SUMMARY OF THE INVENTION

This invention is directed to chewing gums which include a xylitol coating which is produced by applying a xylitol syrup to the surface of a chewing gum piece and drying the syrup to produce a hard coating on the piece. The xylitol syrup is prepared from a xylitol solution which itself is prepared by hydrogenating a xylose solution without the subsequent crystallization step that is commonly employed to produce xylitol in a crystalline form. This significantly reduces the cost of the ingredient and the ‘carbon footprint’ of producing it. When used as an intermediate product from which xylitol is crystallized, this xylitol solution is sometimes referred to as a ‘mother liquor’.

The present invention provides several advantages over prior art compositions. It is an advantage of the present invention to reduce the cost of a xylitol-coated chewing gum composition. It is an advantage of the present invention to reduce the energy necessary to prepare a xylitol-coated chewing gum product. It is an advantage of the present invention to reduce the carbon footprint of a xylitol-coated chewing gum product. These and other advantages will be apparent in light of the full specification of the invention. It is an advantage of the present invention to reduce the amount of time and labor to produce a xylitol-coated chewing gum product by eliminating the need to dissolve crystalline xylitol in water. It is an advantage of the present invention to reduce the level of dust in the factory environment.

Chewing gums in which the present invention is useful will include coated chewing gums in pellet, chunk, ball and other forms. The product may be a bubblegum, a liquid or powder filled gum or other novelty product.

### DESCRIPTION OF THE INVENTION

The present invention provides chewing gum products which include a xylitol coating on the surface of the chewing gum piece.

In some embodiments of the present invention, the chewing gum product will include a xylitol coating which comprises at least 10 wt. % of the finished coated gum product. In some embodiments the chewing gum product will include a xylitol coating which comprises at least 20 wt. % of the finished coated gum product. In some embodiments the chewing gum product will include a xylitol coating which comprises at least 25 wt. % of the finished coated gum product. In some embodiments the chewing gum product will include a xylitol coating which comprises at least 30 wt. % of the finished coated gum product. In some embodiments the chewing gum product will include a xylitol coating which comprises at least 35 wt. % of the finished coated gum product.

In preparing the xylitol syrups of the present invention, it may be necessary to add additional crystalline xylitol to the syrup to bring it up to the right concentration of xylitol for coating. In some embodiments of the present invention, the xylitol solution will provide at least 50 wt. % of the xylitol in the solution. In some embodiments, the xylitol solution will provide at least 60 wt. % of the xylitol in the solution. In some embodiments, the xylitol solution will provide at least 70 wt. % of the xylitol in the solution. In some embodiments, the xylitol solution will provide at least 80 wt. % of the xylitol in the solution. It is possible to create a syrup using only the xylitol present in the xylitol solution, but this may require cooking the solution (or the entire syrup) to reduce the moisture content.

It will typically be desirable or necessary to add additional ingredients to the solution to create an optimal coating syrup. Such ingredients may include a binder such as gum arabic or gum tahla, color such as titanium dioxide, and non-xylitol polyols such as mannitol to control the crystallization rate.

The xylitol solution used in the present invention can be prepared as part of a conventional xylitol manufacturing process. In such processes, biomass containing high levels of xylan (a polymer of xylose) is used as a starting material. Suitable biomass sources for this purpose may include corn cobs, birch wood or other suitable sources. are subjected to acid or enzyme hydrolysis to break the xylan polymer into individual xylose sugar molecules. The biomass is subjected to acid or enzyme hydrolysis to convert the xylan polymer into xylose. Some purification may be performed at this stage such as the removal of waste solids. The xylose solution is then subjected to hydrogenation to convert xylose and any other sugars present into their corresponding sugar alcohols (polyols). Xylose, which forms the majority of the sugars present, it is converted into xylitol during the hydrogenation process.

At this point, the solution would normally be subjected to an energy intensive crystallization step to produce crystalline xylitol. In the present invention, the solution is used directly in a chewing gum composition, with or without concentration by evaporation/cooking.

The xylitol solution may be cooked or evaporated to adjust the level of solids. For example, the syrup may be evaporated to a solids content of 70% or 75% or 80% or 85% or even 90% by weight of the solution, the balance being water. Alternately, crystalline xylitol may be dissolved in the solution or syrup to increase the solids content.

The xylitol solution useful in the present invention will also contain other polyols in small quantities. Typically, these will include arabitol, galactitol and sorbitol. In some embodiments, the xylitol solution will contain at least 1.5% of polyols other than xylitol. In some embodiments, the xylitol solution will contain at least 1.8% of polyols other than xylitol. In some embodiments, the xylitol solution will contain at least 2.2% of polyols other than xylitol. In some embodiments, the xylitol solution will contain at less than 3.0% of polyols other than xylitol. In some embodiments, the xylitol solution will contain at less than 2.5% of polyols other than xylitol. These percentages are based on the weight of dry solids in the solution.

The xylitol solutions of the present invention may also contain a small quantity of un-hydrogenated xylose. It is important that this amount be minimized, particularly in the case where the chewing gum is a sugarless chewing gum. Thus in some embodiments, the xylitol solution will contain less than 0.5% un-hydrogenated xylose. In some embodiments, the xylitol solution will contain at less than 0.25% of un-hydrogenated xylose. In some embodiments, the xylitol solution will contain at less than 0.20% of un-hydrogenated xylose. In some embodiments, the xylitol solution will contain at less than 0.15% of un-hydrogenated xylose. Again, these percentages are based on the weight of dry solids in the solution.

The remainder of the solids in the xylitol solution will comprise xylitol. Thus the solids will comprise at least 96.5% xylitol by weight. In some embodiments, the solids in the xylitol solution will comprise xylitol will comprise at least 97% by weight xylitol. In some embodiments, the solids in the xylitol solution will comprise xylitol will comprise at least 97.5% by weight xylitol. In some embodiments, the solids in the xylitol solution will comprise xylitol will comprise at least 98% by weight xylitol. In some embodiments, the solids in the xylitol solution will comprise xylitol will comprise at least 98.5% by weight xylitol.

Xylitol solutions suitable for use in the present invention may be obtained from crystalline xylitol manufacturers such as Danisco of Europe and Huakang Pharmaceutical Co in Zhejiang, China.

The coating of the chewing gum will be applied as multiple layers of a coating syrup which includes the xylitol solution. In some embodiments, the syrup will include at least 30% of the xylitol solution. In some embodiments, the syrup will include at least 40% of the xylitol solution (wet basis). In some embodiments, the syrup will include at least 50% of the xylitol solution. In some embodiments, the syrup will include at least 60% of the xylitol solution. In some embodiments, the syrup will include at least 70% of the xylitol solution. In some embodiments, the syrup will include at least 80% of the xylitol solution. In some embodiments, the syrup will include at least 90% of the xylitol solution.

The coating syrup may comprise additional crystalline (powdered) xylitol which is dissolved in the solution to increase its solids content. In some embodiments, the syrup will contain at least 5% powdered xylitol on a wet basis. In some embodiments, the syrup will contain at least 10% powdered xylitol. In some embodiments, the syrup will contain at least 15% powdered xylitol. In some embodiments, the syrup will contain at least 20% powdered xylitol. In some embodiments, the syrup will contain at least 25% powdered xylitol. In some embodiments, the syrup will contain at least 30% powdered xylitol on a wet basis.

The coating syrup may further comprise a binding agent such as gum arabic or gum tahla. This may be added to the syrup in the form of a solution, such as a 40% solution. The quantity of binder added to the syrup will typically be at least 2% on a dry basis. In some embodiments, the syrup will comprise at least 2.5% binder. In some embodiments, the syrup will comprise at least 3% binder. In some embodiments, the syrup will comprise at least 3.5% binder. In some embodiments, the syrup will comprise at least 4% binder. In some embodiments, the syrup will comprise at least 5% binder. In some embodiments, the syrup will comprise at least 6% binder. In some embodiments, the syrup will comprise at least 7% binder. In some embodiments, the syrup will comprise at least 8% binder. In some embodiments, the syrup will comprise at least 9% binder. Generally, the level of binder in the syrup will be less than 15% on a dry basis.

The coating syrup may optionally contain a secondary polyol to control crystallization of the xylitol. One preferred polyol for this purpose is mannitol. Where used, the secondary polyol will comprise at least 5% or at least 7% or at least 10% of the syrup on a dry basis. Generally, the secondary polyol will comprise less than 20% or less than 15% of the syrup on a dry basis.

The fundamental components of a chewing gum typically are a water-insoluble gum base portion and a water-soluble bulking agent portion. The primary component of the gum base is an elastomeric polymer which provides the characteristic chewy texture of the product. The gum base will typically include other ingredients which modify the chewing properties or aid in processing the product. These include plasticizers, softeners, fillers, emulsifiers, plastic resins, as well as colorants and antioxidants. The water soluble portion of the chewing gum typically includes a bulking agent together with minor amounts of secondary components such as flavors, high-intensity sweeteners, colorants, water-soluble softeners, gum emulsifiers, acidulants and sensates. Typically, the water-soluble portion, sensates, and flavors dissipate during chewing and the gum base is retained in the mouth throughout the chew.

Any suitable chewing gum base and chewing gum formula may be used to produce a shell for center-filled chewing gums of the present invention. By suitable it is meant that the formula is capable of being processed through the selected equipment.

The insoluble gum base typically may contain any combination of elastomers, vinyl polymers, elastomer plasticizers, fillers, softeners, waxes and other optional ingredients such as colorants and antioxidants. The variety of gum base ingredients typically used provide the ability to modify the chewing characteristics of gums made from the gum base.

Elastomers provide the rubbery, cohesive nature to the gum which varies depending on this ingredient's chemical structure and how it may be compounded with other ingredients. Natural elastomers may include natural rubber such as smoked or liquid latex and guayule, natural gums such as jelutong, lechi caspi perillo, massaranduba balata, massaranduba chocolate, nispero, rosidinha, chicle, gutta percha, gutta kataiu, niger gutta, tenu, chilte, chiquibul, gutta hang kang. Synthetic elastomers may include high molecular weight elastomers such as butadiene-styrene copolymers and isobutylene-isoprene copolymers. Other polymers which sometimes serve as elastomers include polybutadiene and polyisobutylene, vinyl polymers such as polyvinyl acetate, polyethylene, vinyl copolymeric elastomers such as vinyl acetate/vinyl laurate, vinyl acetate/vinyl stearate, ethylene/vinyl acetate, polyvinyl alcohol or mixtures thereof. These polymers perform best when used in combination with butadiene-styrene copolymers and isobutylene-isoprene copolymers.

Vinyl polymeric and copolymeric type elastomers provide tack resistance, vary the chew characteristics of gums made from these bases and offer hydrophilic properties beneficial to sensory perception of the final gums. For copolymeric types, the amount of vinyl laurate, vinyl stearate, or ethylene present in the vinyl laurate/vinyl acetate (VLNA), vinyl stearate/vinyl acetate (VSNA), or ethylene/vinyl acetate (EVA) copolymers respectively typically ranges from about 10 to about 60 percent by weight of the copolymer. Average molecular weights of these polymers may range from about 2,000 to about 80,000. Ball and ring softening points of these polymers may range from about to 50 to 120° C. Polyvinyl acetate having an average molecular weight from about 8,000 to about 52,000 are preferred for use in the gum base and gum of the present invention. More preferred for chewing gum bases are those of from about 10,000 to about 35,000 molecular weight, and for bubble gum bases, those having from about 30,000 to about 60,000 molecular weight. Vinyl polymers typically release flavor quickly, and using iso-alkanic waxes exhibiting small crystalline structure with these vinyl polymers extends flavor release.

It is important that the polymers used in chewing gums of the present invention be food grade. While requirements for being food grade vary from country to country, food grade polymers intended for use as masticatory substances (i.e. gum base) will typically have to meet one or more of the following criteria. They may have to be specifically approved by local food regulatory agencies for this purpose. They may have to be manufactured under “Good Manufacturing Practices” (GMPs) which may be defined by local regulatory agencies, such practices ensuring adequate levels of cleanliness and safety for the manufacturing of food materials. Materials (including reagents, catalysts, solvents and antioxidants) used in the manufacture will desirably be food grade (where possible) or at least meet strict standards for quality and purity. The finished product may have to meet minimum standards for quality and the level and nature of any impurities present, including residual monomer content. The manufacturing history of the material may be required to be adequately documented to ensure compliance with the appropriate standards. The manufacturing facility itself may be subject to inspection by governmental regulatory agencies. Again, not all of these standards may apply in all jurisdictions. As used herein, the term “food grade” will mean that the polymers meet all applicable food standards in the locality where the ingredient or the product incorporating it is manufactured and/or sold.

Petroleum waxes aid in the curing of the finished gum made from the gum base as well as improve shelf-life and texture. Wax crystal size when hard also improves the release of flavor. Those waxes high in iso-alkanes have a smaller crystal size than those waxes high in normal-alkanes, especially those with normal-alkanes of carbon numbers less than 30. The smaller crystal size allows slower release of flavor since there is more hindrance of the flavor's escape from this wax versus a wax having larger crystal sizes.

Synthetic waxes are produced by means atypical of petroleum wax production The synthetic waxes may include waxes containing branched alkanes and copolymerized with monomers such as, but not limited to, propylene and polyethylene and Fischer-Tropsch type waxes. Polyethylene wax is not in the same category as polyethylene, a polymer of ethylene monomers.

Elastomer solvents (sometimes called elastomer plasticizers) vary the firmness of the gum base. Their specificity on elastomer inter-molecular chain breaking (plasticizing) along with their varying softening points cause varying degrees of finished gum firmness when used in base. This is also important when one wishes to provide more elastomeric chain exposure to the alkanic chains of the waxes. Elastomer solvents include natural rosin esters such as glycerol ester of partially hydrogenated rosin, glycerol ester of polymerized rosin, glycerol ester of partially dimerized rosin, glycerol ester of rosin, glycerol ester of tall oil rosin, pentaerythritol esters of partially hydrogenated rosin, partially hydrogenated methyl esters of rosin, pentaerythritol ester of rosin, synthetic elastomer plasticizers such as terpene resins derived from .aipha-pinene, beta-pinene and/or d-limonene, and mixtures thereof. The elastomer solvents used may be of one type or of combinations of more than one. Typically, the ratios of one to the other are dependent on each respective softening point, on each effect on flavor release, and on each respective degree of tack they cause to the gum. Ball and ring softening points of the rosin ester types described above may range from about 60 to about 120° C. Softening points of the terpene resins may range from about 60 to about 130° C. and an average molecular weight of from about 500 to 2,000. Occasionally, both terpene and rosin ester resins may be used together.

Softeners modify the texture, cause the hydrophobic and hydrophilic components of the base to be miscible, and may further plasticize the synthetic elastomers of the gum base. Softeners include fully hydrogenated oils of cottonseed, soybean, palm, palm kernel, coconut, safflower and the like, as well as monoglycerides, diglycerides, acetylated monoglycerides, distilled mono- and digiycerides and de-oiled or “powdered” lecithin. The glycerides and lecithin are sometimes referred to as emulsifiers.

Fillers used in gum base modify the texture of the gum base and aid in processing. Fillers include carbonate or precipitated carbonated types such as magnesium and calcium carbonate, ground limestone and silicate types such as magnesium and aluminum silicate, clay, alumina, talc, as well as titanium oxide, mono- di- and tricalcium phosphate, cellulose polymers such as ethyl, methyl and wood or mixtures thereof.

Other optional ingredients such as antioxidants and colorants may also be used in the gum base. Antioxidants prolong shelf-life and storage of gum base, finished gum or their respective components including fats and flavor oils. Antioxidants suitable for use in gum base or gum of the present invention include butyiated hydroxyanisole (BHA), butylated hydroxytoluene (BHT), beta-carotenes, tocopherols, acidulants such as Vitamin C, propyl gallate, other synthetic and natural types or mixtures thereof in free-flowing ground or pulverized form.

The water-insoluble (gum base) portion of the chewing gum may constitute 5 to 90% by weight of the product. More typically, the gum base will constitute 10 to 50% or 15 to 40% or 20 to 35% by weight of the chewing gum.

The soluble portion of chewing gums is composed of flavoring agents (including sensates such as physiological cooling agents, warming agents and tingling agents), bulking agents (also called bulk sweeteners), high intensity sweeteners, colors, acidulants, fillers, emulsifiers, water soluble softening agents and binders.

Bulk sweeteners include both sugars and sugar alcohols. Bulk sweeteners typically constitute about 5% to about 90% by weight of the chewing gum, more typically, about 20% to about 80% by weight, and more commonly, about 30% to about 60% by weight of the gum. Sugar sweeteners generally include saccharide-containing components commonly known in the chewing gum art, including but not limited to, sucrose, dextrose, maltose, dextrin, dried invert sugar, fructose, galactose, corn syrup solids, and the like, alone or in combination. Sugarless sweeteners include, but are not limited to, sugar alcohols such as sorbitol, mannitol, xylitol, hydrogenated starch hydrolysates, maltitol, erythritol, isomalt and the like, alone or in combination.

High-intensity artificial sweeteners can also be used, alone or in combination, with the above. Preferred sweeteners include, but are not limited to, sucralose, aspartame, N-substituted APM derivatives such as neotame, salts of acesulfame, alitame, saccharin and its salts, cyclamic acid and its salts, glycyrrhizin, dihydrochalcones, thaumatin, monellin, stevia and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Softeners are added to the chewing gum in order to optimize the chewability and mouth feel of the gum. The softeners, which are also known as plasticizers and plasticizing agents, generally constitute between approximately 0.5% to about 15% by weight of the chewing gum. The softeners may include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Combinations of sugar and/or sugarless sweeteners may be used in chewing gum. Additionally, the softener may also provide additional sweetness such as with aqueous sugar or alditol solutions.

If a low calorie gum is desired, a low calorie bulking agent can be used. Examples of low calorie bulking agents include: polydextrose; oligofructose (Raftilose); inulin (Raftilin); fructooligosaccharides (NutraFlora); palatinose oligosaccharide; guar gum hydrolysate (BeneFiber); or indigestible dextrin (Fibersol). However, other low calorie bulking agents can be used.

A variety of flavoring agents can also be used, if desired. The flavor can be used in amounts of about 0.1 to about 15 weight percent of the gum, and preferably, about 0.2% to about 5% by weight. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion. Included in the general category of flavors are sensates, chemicals which impart physiological sensations in the mouth such as cooling agents, warming agents and tingling agents. Examples of cooling agents include menthol, WS-23, WS-3, WS-5, isopulegol, esters of menthol such as menthyl succinate, menthyl lactate and menthyl glutarate, among others. Warming and tingling agents include capsaicin, piperine, jambu and spilanthol.

In some embodiments, the chewing gum ingredients will include one or more high intensity sweeteners. As used herein, the term ‘high intensity sweetener’ refers to any substance that is at least twenty times sweeter than sucrose. Such sweeteners include saccharin, cyclamate, aspartame, alitame, neotame, other peptide-based sweeteners, sucralose, acesulfame K, stevia (including purified extracts such as rebaudioside A), glycyrrhizin, neohesperidin dihydrochalcone and mixtures thereof. In some embodiments, at least a portion of the high intensity sweetener will be encapsulated. Such encapsulations may be produced by granulation, agglomeration, extrusion and grinding, spray drying, fluid bed encapsulation or any other known means. Usage levels will depend on the potency of the sweetener, degree and effectiveness of the encapsulation (if any) as well as the sensory profile desired for the product. Generally, the sweetener will be used at levels as low as 0.005% or as low as 0.05% or at least 0.2% to as high 5% or 3% or 2% in the chewing gum composition. In some embodiments, the high intensity sweetener will be present at a level of 0.1 to 1.0% of the chewing gum ingredients.

In the case of savory flavors such as popcorn, cheese, beef jerky, bacon or potato chip flavors, it may be desirable to include salt in the formula.

In the case of fruit flavored gums, up to 3% of an acid such as citric acid, malic acid or adipic acid may be added for tartness.

The coatings of the present invention are typically applied by pan coating the chewing gum piece. In a pan coating process, centers are tumbled in a pan while doses of the coating syrup are applied, for instance by spraying or ladling. Between applications of the coating syrup, the pellets are dried, preferably by passing a current of heated and/or dried air over or through the pellet bed. Numerous layers of coating are built up, optionally alternating with applications of powdered coating material or an inert filler to accelerate the build-up of the coating. A final layer of a polishing compound, for example carnauba wax, may be applied.

Commonly, two different coating syrups are used in the process. The first syrup will typically have higher solids (lower water) and a higher level of binder (e.g. gum arabic) than the second coating syrup to rapidly build up the coating thickness. The first syrup is applied to create the initial layers of coating. After the coating is built up to about 30% of its final weight, the second syrup is applied to provide a smoother, more pleasing surface.

### EXAMPLES

The following examples illustrate the benefits of the invention.

Chewing gum pellet centers were prepared (formula? Description) The pellet centers weighed approximately 1.0 g each. A sample of xylitol solution having 70% moisture (30% solids) was obtained from Huakang Pharmaceutical Co in Zhejiang, China. The solution contained at least 1.7% of polyols other than xylitol and less than 0.25% xylose by weight of dry solids.

Two syrups were prepared from the 70% xylitol solution according to the formulas in Table 1. Percentages given are based on the total syrup weight including water (wet basis).

TABLE 1

| | Ex. 1 | Ex. 2 |
|---|---|---|
| Xylitol Powder | 26.17 | 15.17 |
| 70% Xylitol Solution | 48.33 | 63.21 |
| Water | — | 3.87 |
| Gum Tahla | 15.00 | 7.75 |
| (40% solution) | | |
| Mannitol | 9.50 | 9.50 |
| Titanium Dioxide | 1.00 | 0.50 |
| Total | 100.00 | 100.00 |
| Percent water | 23.5 | 27.9 |

The chewing gums centers were coated with layers of the syrup of Example 1 and then with layers of the syrup of Example 2 to build the coating to a total weight (center plus coating) of approximately 1.44 g per piece. The coated pellets were polished with carnauba wax.

The coated pellets had a smooth, glossy surface and good crunch when chewed.

Unless otherwise stated all percentages presented here are weight percentages based on the weight of the finished chewing gum composition, not including any optional coatings, fillings or other discrete non-gum portions.

1. A coated chewing gum comprising a chewing gum center comprising 5 to 90% by weight of a gum base, 5 to 90% by weight of a bulking agent and 0.1 to 15% by weight flavor and a coating comprising xylitol wherein the coating is applied as a coating syrup comprising a xylitol solution comprising from 96.5 to 98.5% xylitol and 1.5 to 3.5% of sugars, sugar alcohols other than xylitol or combinations of sugars and sugar alcohols other than xylitol by weight of total solids in the solution.

2. The chewing gum of claim 1 wherein the coating syrup comprises at least 40% of the xylitol solution by weight of the syrup on a wet basis.

3. The chewing gum of claim 1 wherein the coating syrup comprises at least 50% of the xylitol solution by weight of the syrup on a wet basis.

4. The chewing gum of claim 1 wherein the coating syrup comprises at least 60% of the xylitol solution by weight of the syrup on a wet basis.

5. The chewing gum of claim 1 wherein the coating syrup comprises at least 70% of the xylitol solution by weight of the syrup on a wet basis.

6. The chewing gum of claim 1 wherein the coating syrup comprises at least 80% of the xylitol solution by weight of the syrup on a wet basis.

7. The chewing gum of claim 1 wherein the xylitol solution comprises at least 1.5% of polyols other than xylitol by weight of the solids in the solution.

8. The chewing gum of claim 7 wherein the xylitol solution comprises at least 1.8% of polyols other than xylitol by weight of the solids in the solution.

9. The chewing gum of claim 7 wherein the xylitol solution comprises at least 2.2% of polyols other than xylitol by weight of the solids in the solution.

10. The chewing gum of claim 1 wherein the xylitol solution comprises less than 0.5% of xylose by weight of the solids in the solution.

11. The chewing gum of claim 10 wherein the xylitol solution comprises less than 0.25% of xylose by weight of the solids in the solution.

12. The chewing gum of claim 10 wherein the xylitol solution comprises less than 0.20% of xylose by weight of the solids in the solution.

13. The chewing gum of claim 10 wherein the xylitol solution comprises less than 0.15% of xylose by weight of the solids in the solution.

14. The chewing gum of claim 10 wherein the xylitol solution comprises less than 0.25% of xylose by weight of the solids in the solution.

15. The chewing gum of claim 1 wherein the coating syrup further comprises xylitol powder dissolved in the syrup.

16. The chewing gum of claim 15 wherein the coating syrup comprises at least 5% dissolved powder xylitol on a wet basis.

17. The chewing gum of claim 15 wherein the coating syrup comprises at least 10% dissolved powder xylitol on a wet basis.

18. The chewing gum of claim 15 wherein the coating syrup comprises at least 15% dissolved powder xylitol on a wet basis.

19. The chewing gum of claim 15 wherein the coating syrup comprises at least 20% dissolved powder xylitol on a wet basis.

20. The chewing gum of claim 15 wherein the coating syrup comprises at least 25% dissolved powder xylitol on a wet basis.

21. The chewing gum of claim 15 wherein the coating syrup comprises at least 30% dissolved powder xylitol on a wet basis.

22. The chewing gum of claim 1 wherein the xylitol solution is produced by hydrolyzing biomass having a high xylan content to produce a xylose solution, hydrogenating the xylose solution to produce a xylitol solution and optionally evaporating the xylitol solution to a solids content of at least 70%.
